(19) United States
(12) Patent Application Publication
(10) Pub. No.: US 2011/0137993 A1
(43) Pub. Date: Jun. 9, 2011

(54) SYSTEM AND METHOD FOR PROVIDING CONFERENCE SERVICE USING NETWORK SERVICE BASED ON USER TERMINAL CAPABILITIES

(75) Inventors: Jong Hwa YI, Daejeon (KR); Seung-ik Lee, Daejeon (KR); Sung Hei Kim, Daejeon (KR); Wook Hyun, Daejeon (KR); Shin Gak Kang, Daejeon (KR)

(73) Assignee: Electronics and Telecommunications Research Institute, Daejeon (KR)

(21) Appl. No.: 12/962,280

(22) Filed: Dec. 7, 2010

(30) Foreign Application Priority Data
Dec. 7, 2009 (KR) 10-2009-0120546
Aug. 23, 2010 (KR) 10-2010-0081574

(51) Int. Cl. G06F 15/16

(52) U.S. Cl. 709/204

(57) ABSTRACT

A system and method for providing a conference service using a network service based on user terminal capabilities are provided. In the method, it is determined to perform media conversion required for media transfer corresponding to the capabilities of the user terminal in response to a conference service join request, and a transcoding service location of a network device supporting the media conversion is searched over the Internet. Then, a connection is made to the transcoding service location to perform the media conversion, and the converted media is delivered to the user terminal.

### CROSS-REFERENCE TO RELATED APPLICATION

This application claims priority to and the benefit of Korean Patent Application No. 10-2009-0120546 and 10-2010-0081574 filed in the Korean Intellectual Property Office on Dec. 7, 2009 and Aug. 23, 2010, the entire contents of which are incorporated herein by reference.

### BACKGROUND OF THE INVENTION

(a) Field of the Invention

The present invention relates to a system and method for providing a conference service using a network service based on user terminal capabilities.

The present invention relates to a conference system configuration and method that can convert a service registered to be available on a network into an optimum state to allow multimedia transmission depending on the media processing capabilities of the terminal of a user joining a conference service.

(b) Description of the Related Art

In general, conference services are provided in a manner that each media is mixed and delivered to users using a centralized media server in order to process media used in a conference, or in a manner that each terminal does the mixing by itself in the case that a conference is provided without using a media server. To this end, a media server or terminal has to be equipped with a technique for optimizing media codecs and media of various types. This poses the problem that, if one does not have a required codec, it is not possible to get media transferred to process or display it. That is, in order to solve this problem, it is necessary to get a required codec or software downloaded.

Moreover, current available media servers have limits in the number of conferences that can be simultaneously supported or the number of participants for each conference. Thus, a rapid increase in the number of conferences or the number of participants reveals limitations on extensibility.

As above, in order to use a conference, it should be taken into account whether a user terminal functionally supports the use of the service, however, the downloading of a program for using the service to the user terminal each time when needed is cumbersome as well as difficult because of limited sources of the user terminal, and causes an unnecessary increase in traffic. Accordingly, there is an urgent need for means to convert numerous available services present on the Internet into optimized services and provide them depending on the capabilities or location of each user terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a conference system configuration and method that perform media conversion through a transcoding service on a network to achieve optimum media transfer depending on the capabilities of the terminal of a user joining a conference service.

An exemplary embodiment of the present invention provides a system for providing a conference service using a network service depending on user terminal capabilities, the system including:

a service list manager for registering a new conference service and managing registered service list information; a conference manager for determining to perform media conversion required for media transfer corresponding to the capabilities of a user terminal requesting to join the conference service; a service routing path manager for searching for a network device supporting the media conversion over the Internet in response to a request from the conference manager and providing transcoding service location information; and a conference data delivery manager for connecting to the transcoding service location to perform the media conversion and delivering the converted media to the user terminal.

Another exemplary embodiment of the present invention provides a method for providing a conference service using a network service depending user terminal capabilities, the method including: a) determining to perform media conversion required for media transfer corresponding to the capabilities of a user terminal requesting to join the conference service; b) searching for a transcoding service location of a network device supporting the media conversion over the Internet; and c) connecting to the transcoding service location to perform the media conversion and delivering the converted media to the user terminal.

### BRIEF DESCRIPTION OF THE DRAWINGS

FIG. 1 shows a network configuration for providing a conference service through various types of user terminals according to an exemplary embodiment of the present invention.

FIG. 2 is a block diagram showing the configuration of a system for providing a conference service according to the exemplary embodiment of the present invention.

FIGS. 3A and 3B show a conference support procedure of the conference service providing system according to the exemplary embodiment of the present invention.

FIG. 4 shows a block diagram of the service registration, deletion, and search functions of a service list manager according to the exemplary embodiment of the present invention.

FIGS. 5A and 5B show block diagrams of the functions performed by a conference manager according to the exemplary embodiment of the present invention.

FIG. 6 shows a block diagram of the service search function for media conversion of a service routing path manager according to the exemplary embodiment of the present invention.

FIG. 7 shows a per-user media conversion list according to the exemplary embodiment of the present invention.

FIG. 8 shows a block diagram of the function performed by a conference data delivery manager according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a system and method for providing a conference service using a network service based on user terminal capabilities according to an exemplary embodiment of the present invention will be described in detail with reference to the accompanying drawings.

Although conventional services are being developed and provided mainly by service providers or content providers, it is expected that these services will be developed in the future into a flexible service support environment in which general users can easily develop services and officially register and provide them on the Internet or a specific network operator's network. The services as mentioned herein may include services for providing specific element-based functions, such as video transcoding, audio transcoding, text translation, etc., as well as a wide variety of services, such as email, a messaging service, etc.

In this case, according to an exemplary embodiment of the present invention, numerous services available on the Internet can be converted into optimized services and provided depending on the capabilities and location of each user terminal.

For example, in the case that video for wideband codecs (e.g., MPEG4, H.264, etc.) is used in a conference service, one user joining the conference and using a terminal capable of processing general video codecs (e.g., H.263) can only perform media conversion of the video for wideband codecs and then deliver the media by using a transcoding service (i.e., a codec for converting H.264 into H.263) available on the Internet. As such, even when new wideband or advanced codecs are developed in the future, the necessity of having to install these codecs in a terminal can be eliminated, the development costs can be reduced, and services can be provided in an easily extensible way even to a large group of users in different geographical locations who are joining a conference.

Moreover, a user can change their location as needed while joining a conference, and can join the conference using other types of terminals. For example, if a user has to leave the office in the middle of conferencing on a laptop, they can continue joining the conference using their cellular phone. In this case, the user can use the same service with high quality in accordance with the capabilities of the user terminal by getting media transferred and converted into a form suitable for the cellular phone.

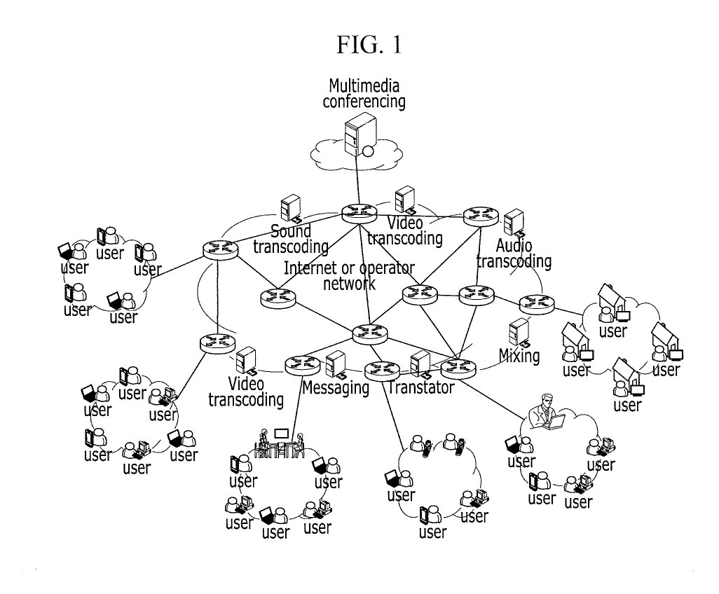

FIG. 1 shows a network configuration for providing a conference service through various types of user terminals according to an exemplary embodiment of the present invention.

Referring to the accompanying FIG. 1, a configuration model in which a multimedia conference service that provides video, audio, image, sound, text, application (e.g., online courses, VoD, etc.) content, and so on is provided to many users is shown, and the users can join the conference using various types of user terminals.

In this configuration model, many services using various types of content are registered on the Internet or on a network operated by a specific network operator, and these services are distributed and managed by Internet or network operator's network equipment (e.g., routers, switches, etc.), and upon a distributed service search request, searching is done by a search algorithm.

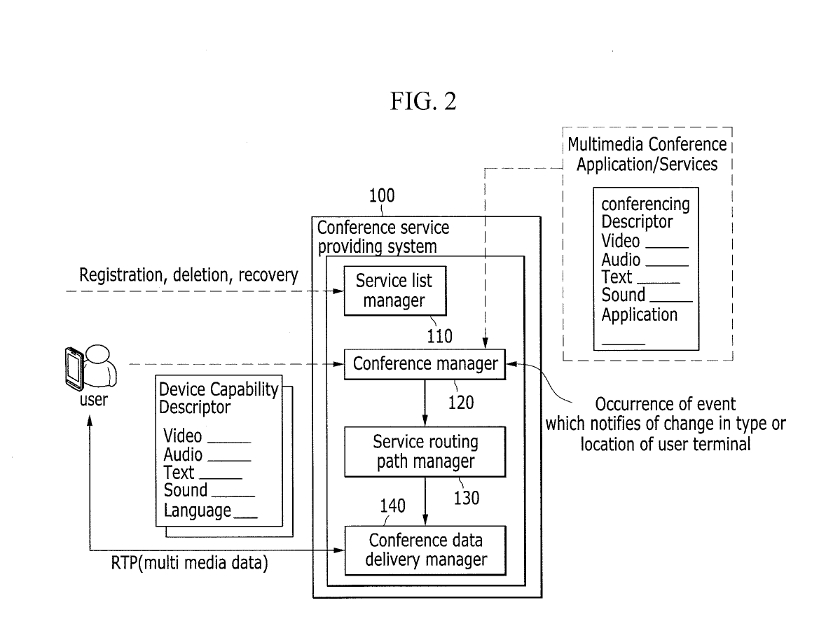

FIG. 2 is a block diagram showing the configuration of a system for providing a conference service according to the exemplary embodiment of the present invention.

The system for providing a conference service using a network service according to the exemplary embodiment of the present invention is installed on the Internet or on network operator's network equipment (e.g., routers, switches, etc.), and functions to search for a function or service required for the provision of the conference service, perform media conversion, and deliver the media to a user over the network depending on the media processing capabilities of the user terminal joining the conference.

Referring to the accompanying FIG. 2, the conference service providing system 100 according to the exemplary embodiment of the present invention includes a service list manager 110, a conference manager 120, a service routing path manager 130, and a conference data delivery manager 140 according to the functions of each module.

The service list manager 110 registers a new service to be available or deletes it, or provides information of its own service list.

The conference manager 120 performs the functions of conference creation/start, joining, withdrawal, etc., manages conference information (conference ID, media type, codecs supported for each media type, etc.) and user terminal information (user terminal ID, media type, codecs supported for each media type, etc.), and determines whether transcoding required for media transfer corresponding to a user terminal is needed. Moreover, upon receipt of a notification of a change in the type or location of the terminal being used by the user, the conference manager 120 re-determines what kind of transcoding is needed for a new terminal of the user. Here, the media includes video (motion pictures), audio, images, sound, text, and so on.

The service routing path manager 130 provides the function of distributed search for a transcoding service (hereinafter, referred to as “conversion service”) for each media type required by the user over the Internet or the network operator's network, and manages transcoding service information (ID, location, etc.) obtained by searching.

Hereinafter, in the present invention, a service routing refers to providing the location and information of a transcoding service, which is the closest to the user terminal, selected from among one or more transcoding services for the same media that the service routing path manager 130 has found.

The conference data delivery manager 140 functions to connect to a service location for conference service data delivery, perform required media conversion, and then deliver the media to the user terminal by using per-user transcoding service information provided by the service routing path manager 130.

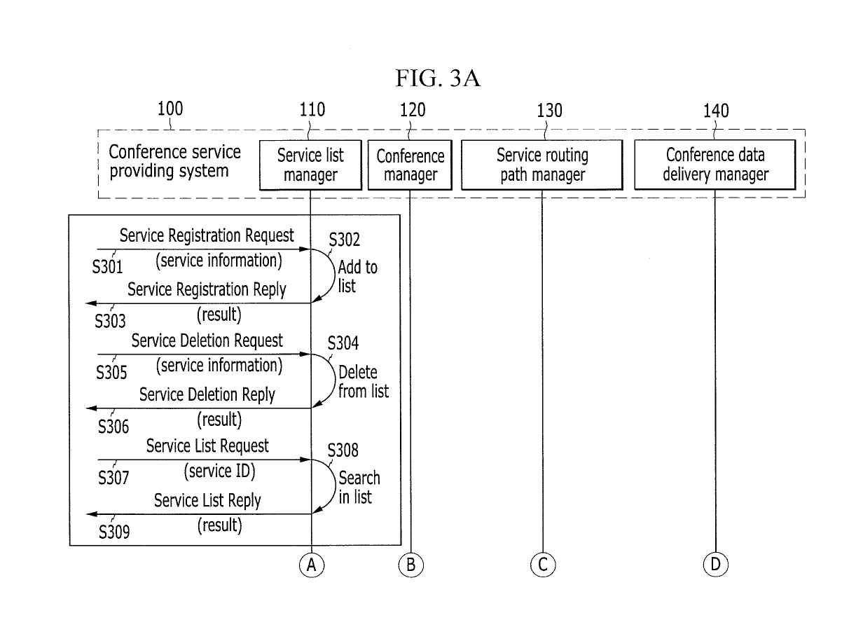

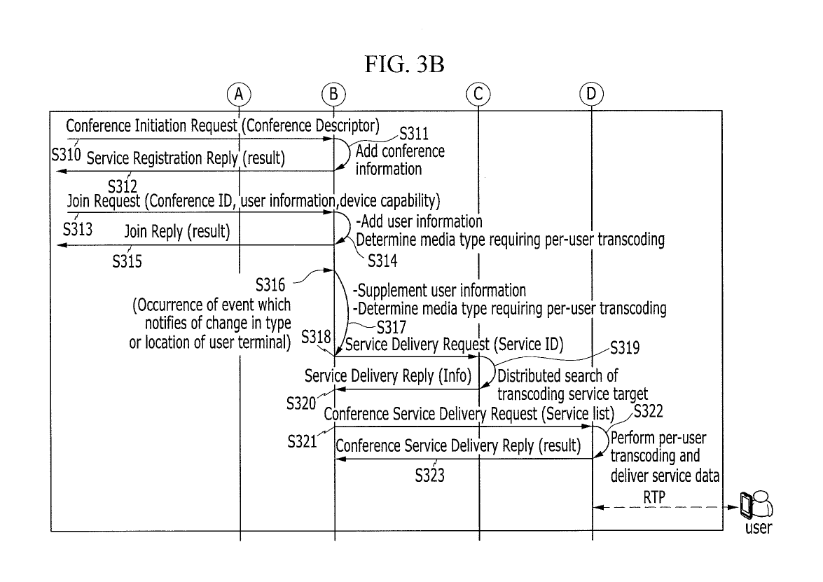

FIGS. 3A and 3B show a conference support procedure of the conference service providing system according to the exemplary embodiment of the present invention.

Referring to the accompanying FIG. 3A, the service list manager 110 according to the exemplary embodiment of the present invention performs service registration for officially registering a new service on the Internet or on a network operator's network, service deletion, and service information search.

That is, upon receipt of a service registration request (S301), the service list manager 110 adds a new service to the list to be available (S302), and acknowledges completion of the service registration (S303).

Moreover, upon receipt of a service deletion request (S304), the service list manager 110 deletes the corresponding service from the list (S305), and acknowledges completion of the service deletion (S306).

Further, upon receipt of a service list request (S307), the service list manager 110 searches for a service in the registered service list based on a requested service ID (S308), and provides the searched service information (S309).

Next, referring to the accompanying FIG. 3B, the conference manager 120 creates a conference, and determines whether it is necessary to perform additional media conversion on the network before each media transfer by using user terminal capability information input when a user joins.

That is, upon receipt of a conference initiation request from the user terminal (S310), the conference manager 120 generates new conference information based on a received conference descriptor (S311), and acknowledges completion of the conference initiation (S312).

The conference manager 120 receives a conference join request from the user terminal (S313). Information of the conference join request includes a conference ID the user wants to join, user information, and supportable media capability information of at least one of video, audio, image, sound, and text for the user terminal.

The conference manager 120 adds received user terminal capability information to the corresponding conference, determines a media type requiring per-user transcoding for a conference service (S314), and sends an acknowledgment of completion of the conference join request to the user terminal (S315).

When an event notifying of a change in the type or location of the user terminal joining the conference is generated (S316), the conference manager 120 supplements stored user and user terminal information with the change, and re-determines a media type requiring per-user transcoding (S317).

Next, if necessary, the service providing system 100 searches for service information among distributed network equipment to find the service location and perform media conversion, and can finally perform the following procedure of delivery to the user terminal.

The conference manager 120 requests the service routing path manager 130 to search for a transcoding service using a service ID (S318), and the service routing path manager 130 performs a distributed search of a transcoding service target (S319) and returns the location and information of the transcoding service found by searching to the conference manager 120 (S320).

Afterwards, the conference manager 120 sends a per-user media conversion list to the conference data delivery manager 140 to request the delivery of the conference service (S321), and the conference data delivery manager 140 performs per-user transcoding and then delivers service data to the user terminal (S322). Then, a conference data delivery result is sent to the conference manager 120 (S323).

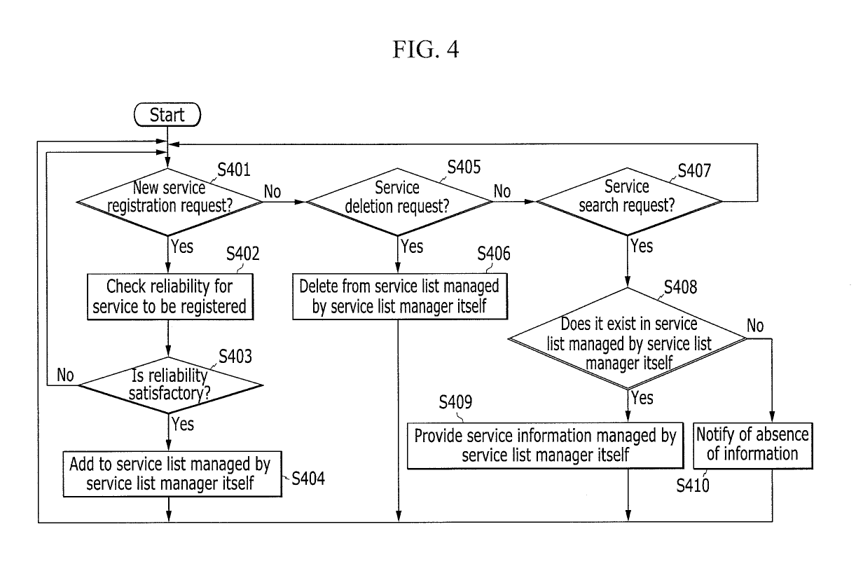

FIG. 4 shows a block diagram of the service registration, deletion, and search functions of the service list manager according to the exemplary embodiment of the present invention.

Referring to the accompanying FIG. 4, a more detailed illustration of a flow in which the service list manager 110 according to the exemplary embodiment of the present invention performs the service registration, deletion, and search functions in response to a particular request is provided.

When there is a new service registration request (S401), the service list manager 110 checks the reliability of a service to be registered (S402) to determine whether the reliability is satisfactory (S403). Reliability satisfaction is determined according to a service policy that a provider providing a conference-type service of the present invention applies. If the reliability is not satisfactory as a result of the determination, the result is ignored or the flow goes back to the step S401 to enter into a standby state, and if the reliability is satisfactory, the service information is added to the service list managed by the service list manager 110 (S404).

Alternatively, when there is a service deletion request (S405), the service list manager 110 deletes a requested service from its own service list (S406).

Alternatively, when there is a service search request (S407), the service list manager 110 checks whether a requested service in its own service list exists (S408), and if the requested service exists, provides the corresponding service information managed by itself (S409). On the other hand, if the requested service does not exist in the step S408, the object that has requested the service search is notified of the absence of service information (S410).

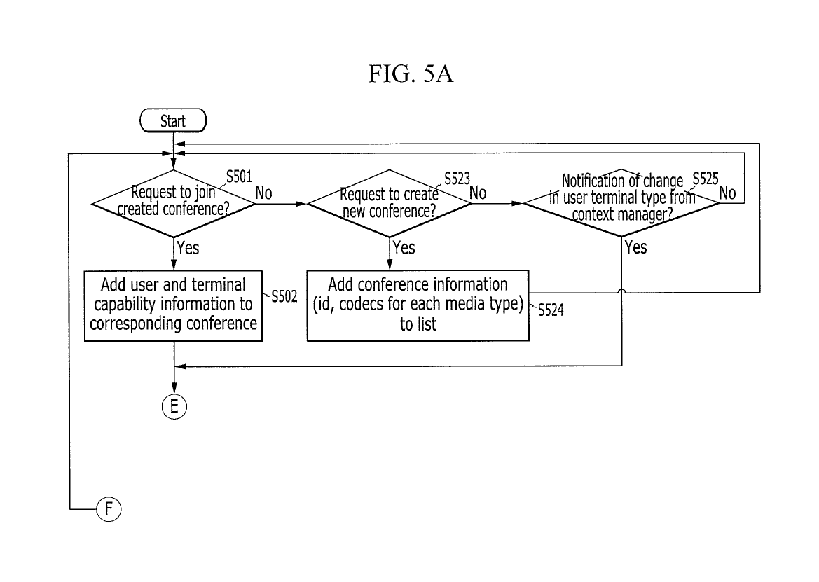

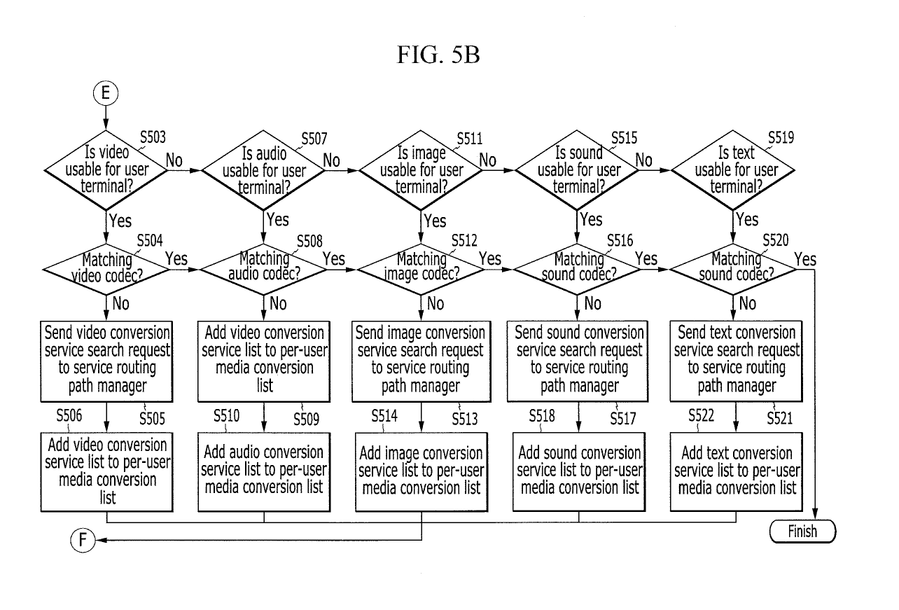

FIGS. 5A and 5B show block diagrams of the functions performed by the conference manager according to the exemplary embodiment of the present invention.

Referring to the accompanying FIGS. 5A and 5B, a procedure is illustrated in which, when a user joins a conference, user terminal capability information is input to compare and analyze codecs for each media type supported by the conference service and determine whether media conversion is required, and a request for a required transcoding service is sent to the service routing path manager 130 to obtain information.

When there is a conference join request for the conference created by the conference descriptor of the user terminal (S501, Yes), the conference manager 120 adds the user and terminal capability information to the corresponding conference (S502). The conference descriptor includes supportable media capability information of at least one of video, audio, image, sound, and text for the user terminal.

The conference manager 120 checks whether video can be used for the user terminal (S503), and if so, determines whether there is a video codec matching a video codec to be used for the conference among at least one video codec that can be used in the user terminal (S504).

If there is no matching video codec, a video conversion service search request is sent to the service routing path manager 130 (S505), and upon receipt of a result of the request, the video conversion service location is added to the per-user media conversion list (S506).

Next, the conference manager 120 checks whether audio can be used for the user terminal (S507), and if so, determines whether there is an audio codec of the user terminal that matches an audio codec to be used for the conference (S508). If there is no matching audio codec, an audio conversion service search request is sent to the service routing path manager 130 (S509), and upon receipt of a result of the request, the audio conversion service location is added to the per-user media conversion list (S510).

Next, the conference manager 120 checks whether images can be used for the user terminal (S511), and if so, determines whether there is an image codec of the user terminal that matches an image codec to be used for the conference (S512). If there is no matching image codec, an image conversion service search request is sent to the service routing path manager 130 (S513), and upon receipt of a result of the request, the image conversion service location is added to the per-user media conversion list (S514).

Next, the conference manager 120 checks whether sound can be used for the user terminal (S515), and if so, determines whether there is a sound codec of the user terminal that matches a sound codec to be used for the conference (S516). If there is no matching sound codec, a sound conversion service search request is sent to the service routing path manager 130 (S517), and upon receipt of a result of the request, the sound conversion service location is added to the per-user media conversion list (S518).

Next, the conference manager 120 checks whether text can be used for the user terminal (S519), and if so, determines whether there is a text codec of the user terminal that matches a text codec to be used for the conference (S520). If there is no matching text codec, a text conversion service search request is sent to the service routing path manager 130 (S521), and upon receipt of a result of the request, the text conversion service location is added to the per-user media conversion list (S522).

Meanwhile, if there is a new conference creation request (S523), the conference manager 120 adds conference information (ID, codec information for each media type) to the list (S524), and performs the step S501.

Moreover, upon receipt of a notification of a change in the type of user terminal from a context manager (S525), the conference manager 120 changes the type of user terminal to the changed type, and re-determines a media type requiring per-user transcoding by performing the steps S503 to S522.

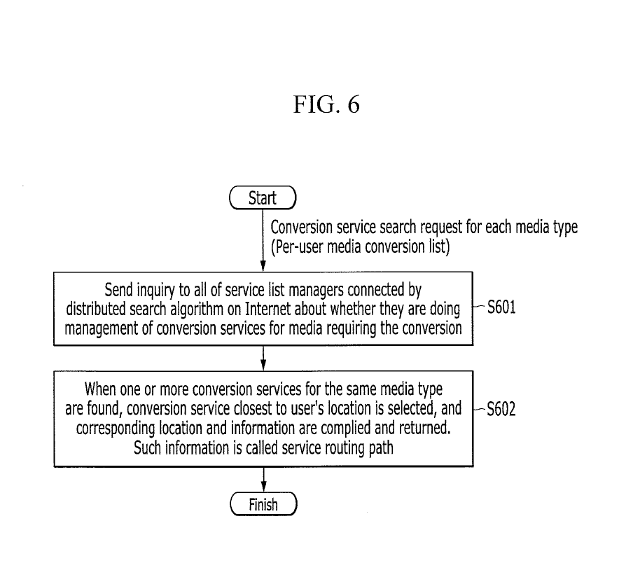

FIG. 6 shows a block diagram of the service search function for media conversion of the service routing path manager according to the exemplary embodiment of the present invention.

Referring to the accompanying FIG. 6, the service routing path manager 130 according to the exemplary embodiment of the present invention receives a conversion service search request for each media type from the conference manager 120 (S601). The conversion service search request for each media type includes a per-user media conversion list.

The service routing path manager 130 sends an inquiry to all of service list managers 110 connected by a distributed search algorithm on the Internet regarding whether they are doing the management of conversion services for media requiring the conversion (S602).

When one or more conversion services for the same media type are found, the service routing path manager 130 functions to select a conversion service closest to the user's location, compile the location and information of the selected conversion service, and then return them to the conference manager 120.

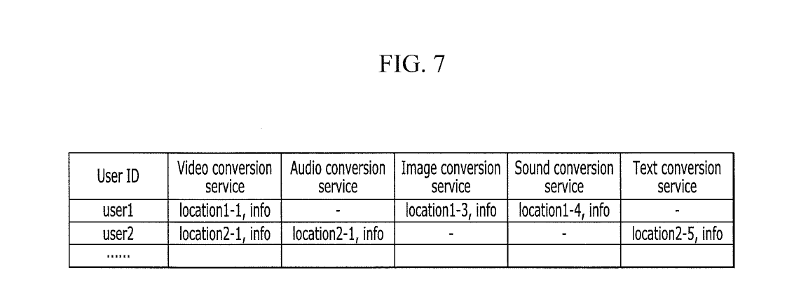

FIG. 7 shows a per-user media conversion list according to the exemplary embodiment of the present invention.

Referring to the accompanying FIG. 7, the per-user media conversion list stores a user ID and locations/information of a video conversion service, an audio conversion service, an image conversion service, a sound conversion service, and a text conversion service according to the necessity of media conversion. That is, userl requires the video conversion service, the image conversion service, and the sound conversion service, and the service routing path manager 130 compiles and stores the locations and information of the respective conversion services.

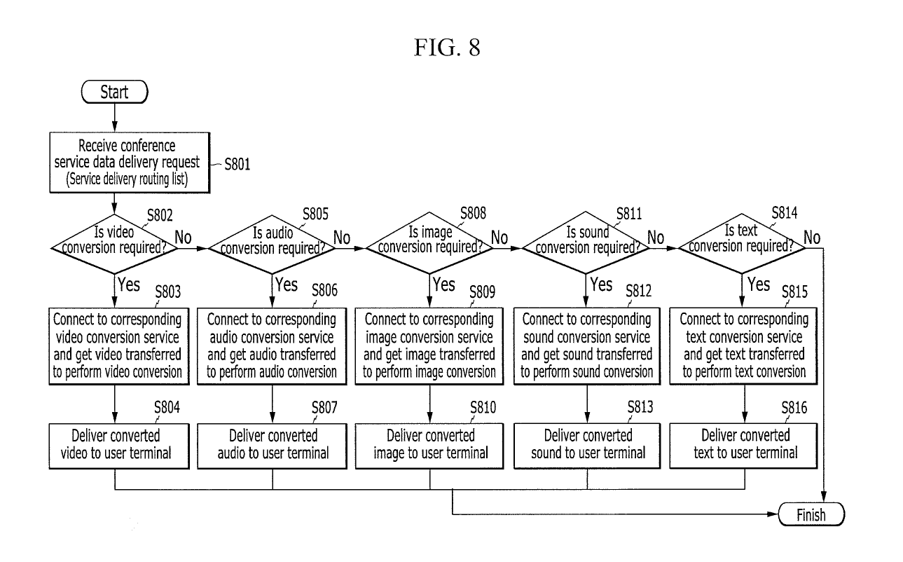

FIG. 8 shows a block diagram of the function performed by the conference data delivery manager according to the exemplary embodiment of the present invention.

Referring to the accompanying FIG. 8, an illustration of a procedure in which, based on the returned per-user media conversion list, the conference data delivery manager 140 connects to network equipment with transcoding services for each media type located therein and gets media transferred to perform conversion and deliver the media to the user terminal is provided.

Concretely, the conference data delivery manager 140 according to the exemplary embodiment of the present invention receives the per-user media conversion list in response to the conference service data delivery request from the conference manager 120 (S801).

Next, the conference data delivery manager 140 checks whether video conversion is required (S802). If conversion is required, the conference data delivery manager 140 connects to the corresponding video conversion service and gets video transferred to perform video conversion based on the per-user media conversion list (S803). Then, the converted video is delivered to the user terminal (S804).

In the step S802, if video conversion is not required, it is checked whether audio conversion is required as in the above video conversion. If so, a connection is made to the corresponding audio conversion service to perform conversion and deliver the converted media to the user terminal (S805 to S807). In addition, after the step S807, if necessary, image conversion, sound conversion, and text conversion may also be performed, and the converted media may be delivered to the user terminal in the same manner. Descriptions thereof will be similar to those of the above-described video and audio conversions and are predictable, so they will be omitted (S808 to S816).

As seen from the above, when providing a conference service to a plurality of users, media transcoding required depending on the media processing capabilities of a user terminal joining the conference is performed on the Internet or on a network operator's network, and converted media is delivered to the user terminal, thereby eliminating the necessity of having to use various codecs in a terminal and reducing the development costs. Moreover, when new codecs, such as wideband codecs, simultaneous multimedia support codecs, etc., are developed in the future, they do not need to be installed individually in a terminal but they can be simply registered to be operable on a network, thus enabling flexibly and to actively provide the same service in a distributed way even when the user changes their terminal type.

Further, individual users, as well as service providers and content providers, can develop media conversion functions and register and provide them according to an official procedure, thus contributing to the creation and activation of new services.

The exemplary embodiment of the present invention is not implemented only by a device and/or a method, but can be implemented through a program for realizing functions corresponding to the configuration of the exemplary embodiments of the present invention and a recording medium having the program recorded thereon. Such implementation can be easily made by a skilled person in the art to which the present invention pertains from the above description of the exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A conference service providing system, comprising:
a service list manager for registering a new conference service and managing registered service list information;
a conference manager for determining to perform media conversion required for media transfer corresponding to the capabilities of a user terminal requesting to join the conference service;
a service routing path manager for searching for a network device supporting the media conversion over the Internet in response to a request from the conference manager and providing transcoding service location information; and
a conference data delivery manager for connecting to the transcoding service location to perform the media conversion and delivering the converted media to the user terminal.

2. The system of claim 1, wherein the conference manager manages conference information including the conference ID of the registered service, a media type, and codecs supported for each media type, and determines to perform the media conversion by comparing the user terminal capabilities with the conference information.

3. The system of claim 1, wherein, when the type or location of the user terminal joining the service is changed, the conference manager re-determines to perform media conversion required for the changed type or location of the user terminal.

4. The system of claim 3, wherein the conference manager stores the transcoding service location information in a per-user media conversion list.

5. The system of claim 4, wherein the conference data delivery manager performs media conversion of at least one of video, audio, image, sound, and text for each user based on the per-user media conversion list, and delivers the media to each user terminal.

6. The system of claim 1, wherein, when one or more transcoding services for the same media type are found, the service routing path manager selects and provides the transcoding service closest to the user terminal's location.

7. A method for providing a conference service using a network service depending on user terminal capabilities, the method comprising:
determining to perform media conversion required for media transfer corresponding to the capabilities of a user terminal requesting to join the conference service;
searching for a transcoding service location of a network device supporting the media conversion over the Internet; and
connecting to the transcoding service location to perform the media conversion and delivering the converted media to the user terminal.

8. The method of claim 7, further comprising, before the determining, registering a new conference service and storing a conference ID and codec information for each media type.

9. The method of claim 7, wherein the determining comprises:
checking media capability information of at least one of video, audio, image, sound, and text for the user terminal in response to the conference service joint request; and
comparing codec information for each media type of the user terminal with codecs for each media type supported by the conference service, and if there is no match, determining that media conversion is required.

10. The method of claim 7, wherein the searching comprises:
searching for transcoding service locations of all network equipment connected by a distributed search algorithm; and
selecting a transcoding service location based on the user's location.

11. The method of claim 7, further comprising, after the connecting:
checking for a type or location change event of the user terminal joining the service; and
re-determining to perform media conversion required for the change in the type or location of the user terminal.
